(19) United States
(12) Patent Application Publication
(10) Pub. No.: US 2015/0232149 A1
(43) Pub. Date: Aug. 20, 2015

(54) Jumping drive device

(71) Applicants: Wei Song, Houston, TX (US); Ning Zhu, Beijing (CN); Feng Zhu, Chang Tu (CN)

(72) Inventors: Wei Song, Houston, TX (US); Ning Zhu, Beijing (CN); Feng Zhu, Chang Tu (CN)

(21) Appl. No.: 14/181,759

(22) Filed: Feb. 17, 2014

(51) Int. Cl. B62M 1/10; F16D 41/30; B62K 21/02; B62K 3/00; A63B 25/08

(52) U.S. Cl. CPC B62M 1/105; B62K 3/002; A63B 25/08; B62K 21/02; F16D 41/30

(57) ABSTRACT

A non-motorized scooter with jumping drive device taking the advantages of scooter and pogo-stick. It has two models:

1, It is designed for low-age kids with slow speed and easily to control the device;

2, It is assembled an accelerator to increase moving speed which is for higher age kids.

A user can operate the device by standing on two peddles and jumping up and down to produce momentum moving forward.

### CROSS-REFERENCE TO RELATED APPLICATIONS

None.

### FEDERALLY SPONSORED RESEARCH

None.

### SEQUENCE LISTING OR PROGRAM

None.

### BACKGROUND OF THE INVENTION

1. The Field of the Invention

The present invention relates to a novel jumping driving device especially for scooter type apparatus taking advantage of characteristics both scooter moving fast on the ground-level and pogo stick jumping up and down in the vertical direction.

2. Description of the Prior Art

Various scooter and pogo stick designs have been available for many years. Conventional scooters require the user to lift one foot from the scooter-board and down to the ground to kick back hard in order to get propulsion. It must be very tired for a longer riding. For pogo sticks, in addition, it can provide a exciting movement mode up and down by jumping for the user but it is greatly limited to move forward quickly. What is needed is a new improving design without such limitations.

### SUMMARY OF THE INVENTION

A Jumping Driving Device is designed for scooter type apparatus. It comprises a support rod provided with a front driving-leg and a rear driving-leg at its lower end. Two wheels are provided at each end of the front driving-leg and the rear driving-leg. A elastic thing links two lower parts of the front driving-leg and the rear driving-leg. One-way clutches are provided at each wheel. By the aid of elastic thing the user stands on foot-rests and can easily jumps up and down quickly. Just like man's side-walking, the two driving-legs would keep providing momentum alternately and the device moves forward.

### BRIEF DESCRIPTION OF THE DRAWINGS

Preferred embodiment of the present invention will be two wheels scooter type apparatus. Now it will be described with reference to drawings in which:

FIG. 1 is a perspective view of present invention.

FIG. 2 is a illustration of driving principle as two driving-legs contracting.

FIG. 3 is a illustration of driving principle as two driving-legs separating.

FIG. 4 is a illustration of steering system.

FIG. 5 is a detail view of driving-leg turning-limiter shown in FIG. 1.

FIG. 6 is a perspective view of preferred embodiment with two rear wheels.

FIG. 7 is a perspective view of two driving-legs.

FIG. 8 is detail back view of two rear wheels shown in FIG. 6.

FIG. 9 is diagrams of one-way clutch.

FIG. 10 is a perspective view of one-way clutch.

FIG. 11 is a diagram of another type one-way clutch.

FIG. 12 is other type of one-way clutch.

FIG. 13 is a side view of second embodiment with gear-accelerator as two driving-legs contracting.

FIG. 14 is a side view of second embodiment with gear-accelerator as two driving-legs separating.

FIG. 15 is a detail side views of gear-accelerator.

FIG. 16 is other side detail side view of gear-accelerator.

FIG. 17 is a perspective detail view of gear-accelerator.

FIG. 18 is a perspective view of second embodiment with gear-accelerator.

FIG. 19 is a side view of third embodiment with pulling-accelerator as two driving-legs contracting.

FIG. 20 is a side view of third embodiment with pulling-accelerator as two driving-legs separating.

FIG. 21 is a perspective view of rear wheel with jumping-pulling device;

FIG. 22 is a cross section view of rear wheel with jumping-pulling device;

FIG. 23 is section view along line A-A in FIG. 21;

FIG. 24 is detail section view along line B-B in FIG. 21.

FIG. 25 is a perspective view of third embodiment.

FIG. 26 is a perspective view of fourth embodiment with pull-chain accelerator.

FIG. 27 is diagram of pull-chain accelerator.

FIG. 28 is detail view of friction drive wheel.

FIG. 29 is a perspective view of fifth embodiment of scooter.

### DESCRIPTION OF THE PREFERRED EMBODIMENT

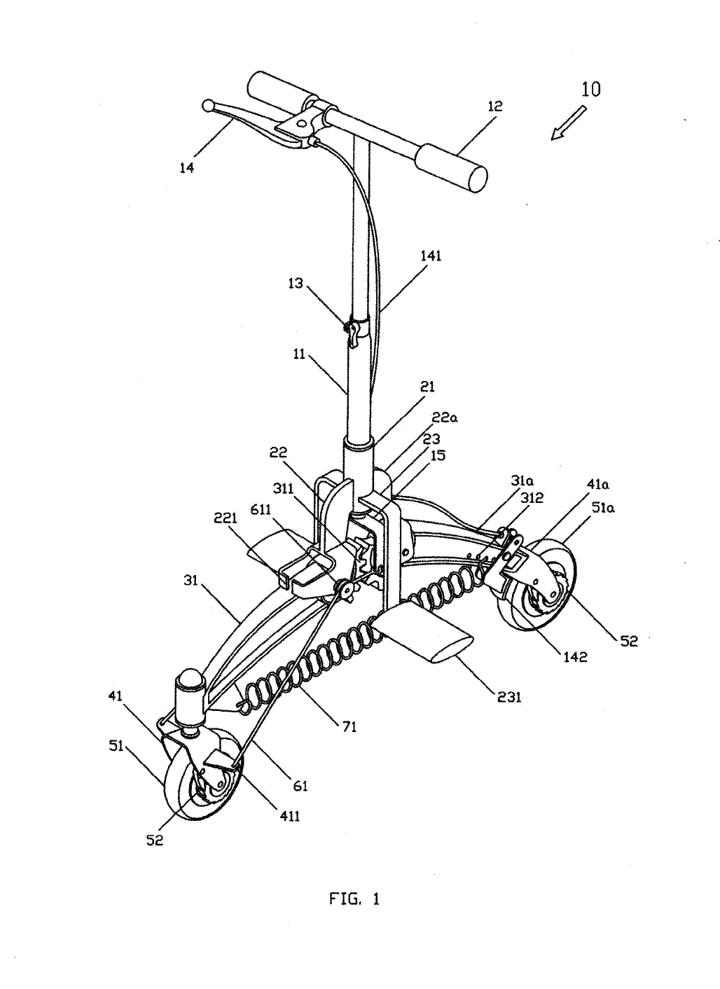

Referring first to FIG. 1: The device 10 includes:
Support rod 11 includes upper part and lower part telescopically connected and locked by locker 13.
Hand grips 12 secured to upper end of support rod 11.
Brake lever 14 located proximally to hand grips 12 linking brake-shoe 142 by brake-wire 141.
Steering fork 15 secured to lower end of support rod 11.
Axle sleeve 21 rotatively connected to the lower part of support rod 11.
Front bearings 22 and rear bearing 22a fixed to front side and back side of axle sleeve 21.
Foot-rest 231 fixed to axle sleeve 21 by rod 23.
Front driving-leg 31 rotatively connected at its upper end with front bearing 22.
Front fork 41 rotatively mounted at lower end to front driving-leg 31.
Front wheel 51 rotatively mounted on front fork 41.
Rod 411 fixed to front fork 41.
One-way clutch 52 provided to front wheel 51.
Groove wheel 611 rotatively provided at outside of front bearing 22.
Turning limiter 221 is formed at lower edge of front bearing 22.
Rear driving-leg 31a rotatively connected at its upper end with rear bearing 22a.
Rear fork 41a provided at lower end of rear driving-leg 31a.
A synchronous device 311 comprises two fan-shaped gears provide at both upper ends of front driving-leg 31 and rear driving-leg 31a engaging each other.
Rear wheel 51a rotatively mounted on rear fork 41a.
One-way clutch 52 provided to rear wheel 51a.
Elasticity adjusting holes 312 are provided at lower parts of rear driving-leg 31a.
Steering-wire 61 linked steering fork 15 and rod 411 via groove wheel 611.
Elastic thing 71 linking both lower parts of front driving-leg 31 and rear driving-leg 31a.

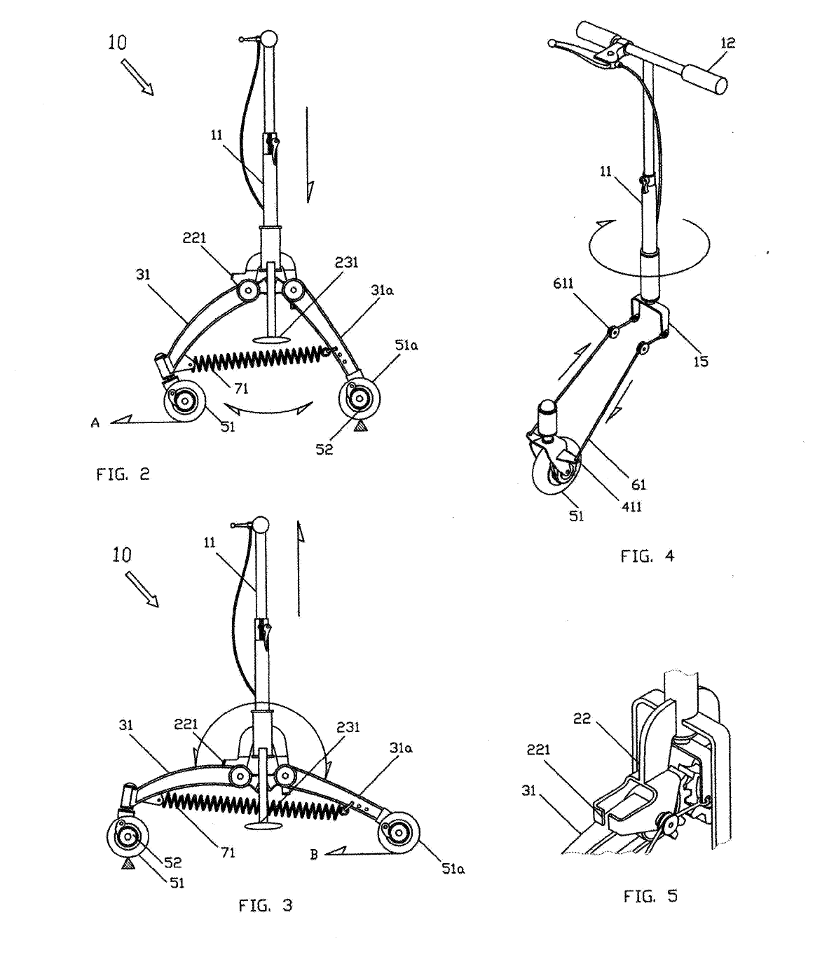

FIG. 2, 3 illustrate driving principle. Elasticity of elastic thing 71 should be adjusted little smaller than weight of user. The user stands on foot-rests 231, the device 10 would fall down and two driving-legs 31 and 31a will separate each other simultaneously till to be blocked by turning-limiter 221. As the result of the work of one-way clutch 52, rear wheel 51a would be locked and front wheel 51 together with the device 10 will be pushed forward in the direction shown as arrow A.

When the user jumps up by the aid of elasticity of elastic thing 71, front driving-leg 31 and rear driving-leg 31a will contract and front wheel 51 would reverse back but it is locked by one-way clutch 52 while rear wheel 51a will be released and pulled forward in the direction shown as arrow B.

FIG. 4 shows work-mode of steering system. Turning hand grips 12, steering fork 15 will be turn synchronously. Via steering-wire 61 and rod 411 leading by groove wheel 611 front wheel 51 will turn accordingly.

FIG. 5 is a detail of turning-limiter 221 formed by part of lower edge of front bearing 22 bent inwards.

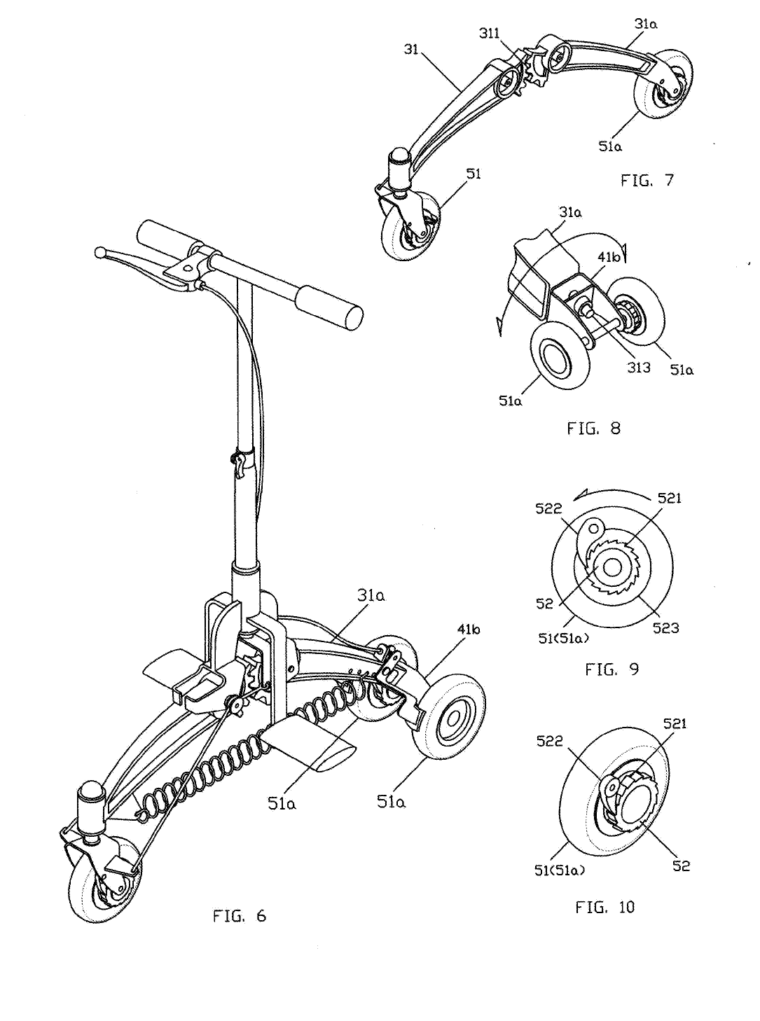

FIG. 6 shows a perspective view of the preferred embodiment with two rear Wheels 51a.

FIG. 7 shows under the limit of synchronous device 311 front driving-leg 31 and rear driving-leg 31a only turn synchronously but in the opposite direction.

FIG. 8 is a detail back view of embodiment shown in FIG. 6 indicating rear fork 41b provided with two rear wheels 51a rotatively connected with axle 313 fixed to rear driving-leg 31a.

FIG. 9, 10 show structure of one-way clutch 52 which comprises ratchets 521 and check pawl 522 arranged one-side of hub 523. Check pawl 522 always keeps in touch with ratchets 521 by a small spring (unshown in FIG. 9, 10). While wheel 51 (51a) runs forward check pawl 522 would slide over teeth of ratchets 521. While wheel 51 (51a) reverses ratchets 521 will be blocked by check pawl 522.

FIG. 11 shows another one-way clutch with ratchets 521 and check pawl 522 arranged inside of hub 523.

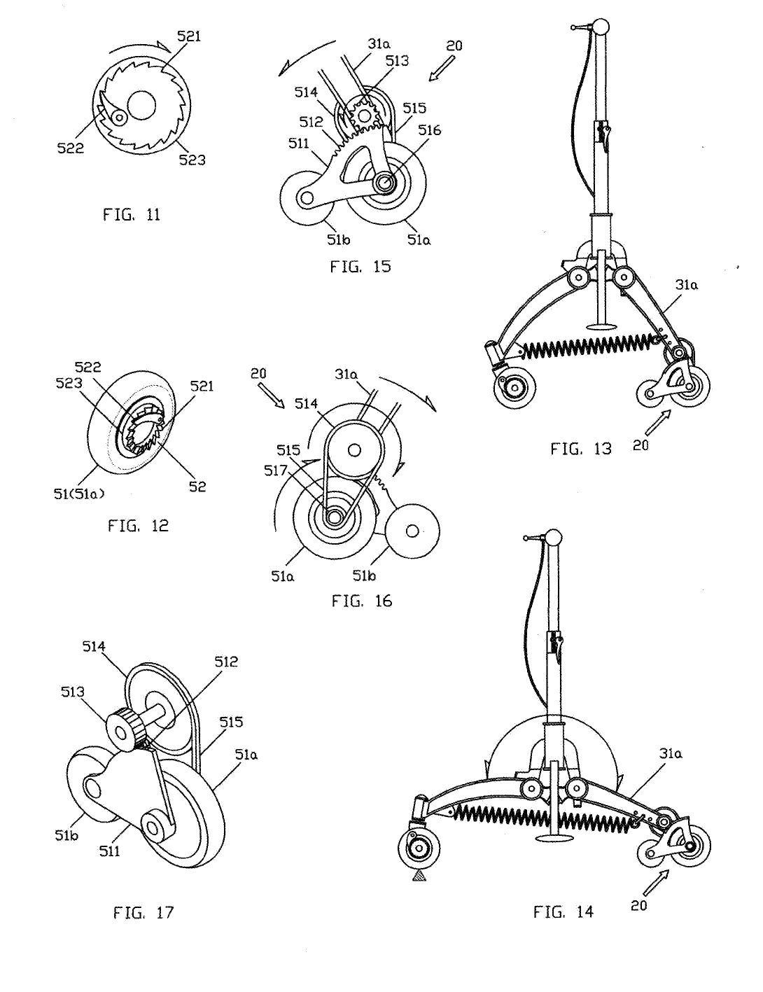

FIG. 12 is a other kind of one-way clutch. Teeth of ratchets 521 is arranged at flank of hub 523.

FIGS. 13,14 and 18 show second embodiment with gear-accelerator 20 at lower end of rear driving-leg 31a.

FIG. 15 is detail side view of gear-accelerator. A auxiliary wheel 51b provided in the front of rear wheel 51a. A arc-rack 512 is formed along upper edge of bearing 511 rotatively mounted around rear axle 516. One-way gear 513 engaged with arc-rack 512 is rotatively mounted on rear driving-leg 31a.

FIG. 16 shows other side view of accelerator. Chain-wheel 514 is secured to gear 513 by a axle and connected with free-wheel 517 secured to rear wheel 51a by chain 515.

When rear driving-leg 31a separating, it will turn forward around rear axle 516, gear 513 will roll forward along arc-rack 512 and making itself rotating at the same time. Chain-wheel 514 will turn simultaneously and drive free-wheel 517 to turn secured to rear wheel 51a via chain 515.

FIG. 17 is a perspective detail view of gear-accelerator 20.

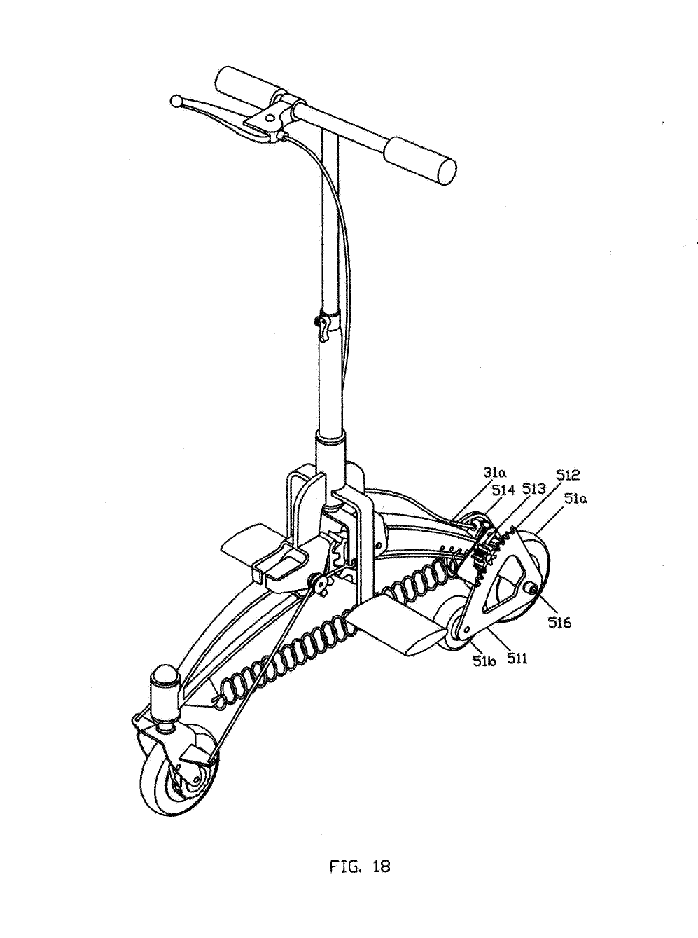

FIG. 18 is a perspective view of second embodiment with gear-accelerator.

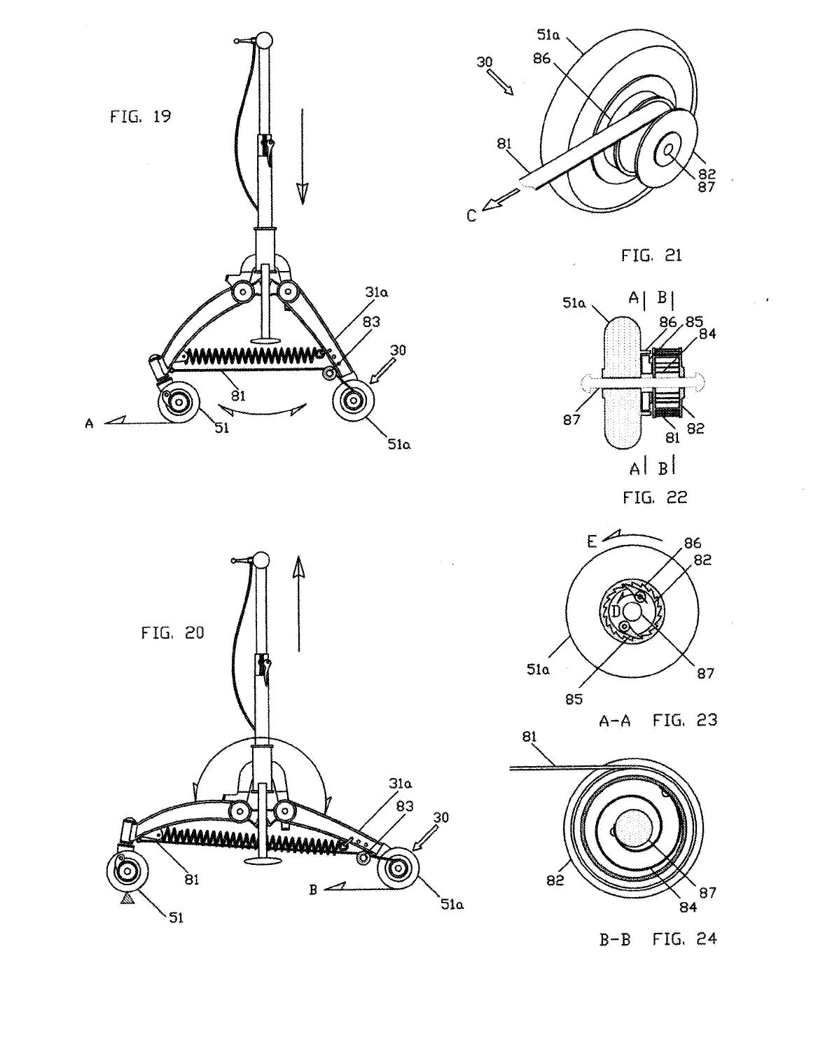

FIG. 19, 20 are side views of third embodiment with pulling-accelerator 30.

FIG. 21 is a perspective view of rear wheel 51a provided with pulling-accelerator 30. Ratchet-ring 86 secured to wheel 51a. Soft pull thing 81 can be pull out from spiral return groove 82 via groove 83 and reroll up back under elasticity of spiral return spring 84.

FIG. 22 is a cross section view of pulling-accelerator 30.

FIG. 23, 24 show working principle of pulling-accelerator 30. Rear wheel 51a and spiral return spring groove 82 rotatively mounted to axle 87. Spiral return spring 84 secured with one end to axle 87 and another end to spiral return spring groove 82. Soft pull thing 81 secured to spiral return spring groove 82 and wind round it. While soft pull thing 81 is pull in the direction C out of spiral return groove 82, spiral return groove 82 will turn along check pawl 85 at the direction of arrow D. Check pawl 85 is engaged with clutch teeth 86 secured to rear wheel 51a and make rear wheel 51a turning together at the direction of arrow E, providing momentum of moving forward. While two driving-legs 31 and 31a contract, soft pull thing 81 will be rerolled up by the elasticity of spiral return spring 84 via groove 83 and due to one-way clutch rear wheel 51a would not turn backwards together.

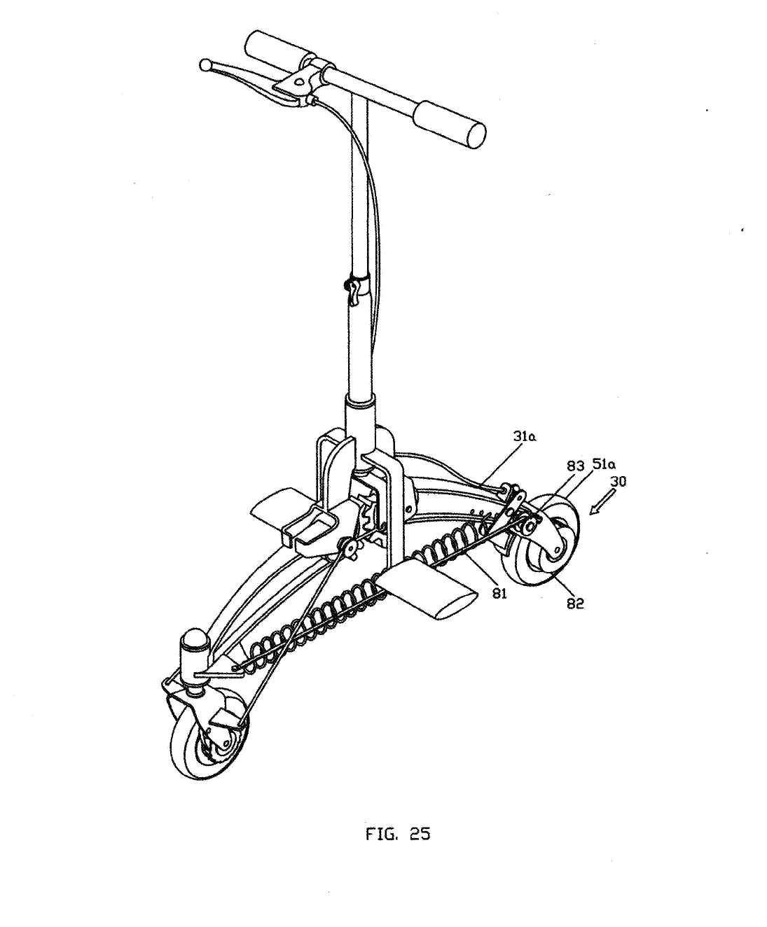

FIG. 25 shows perspective view of third embodiment of the invention with pulling-accelerator 30.

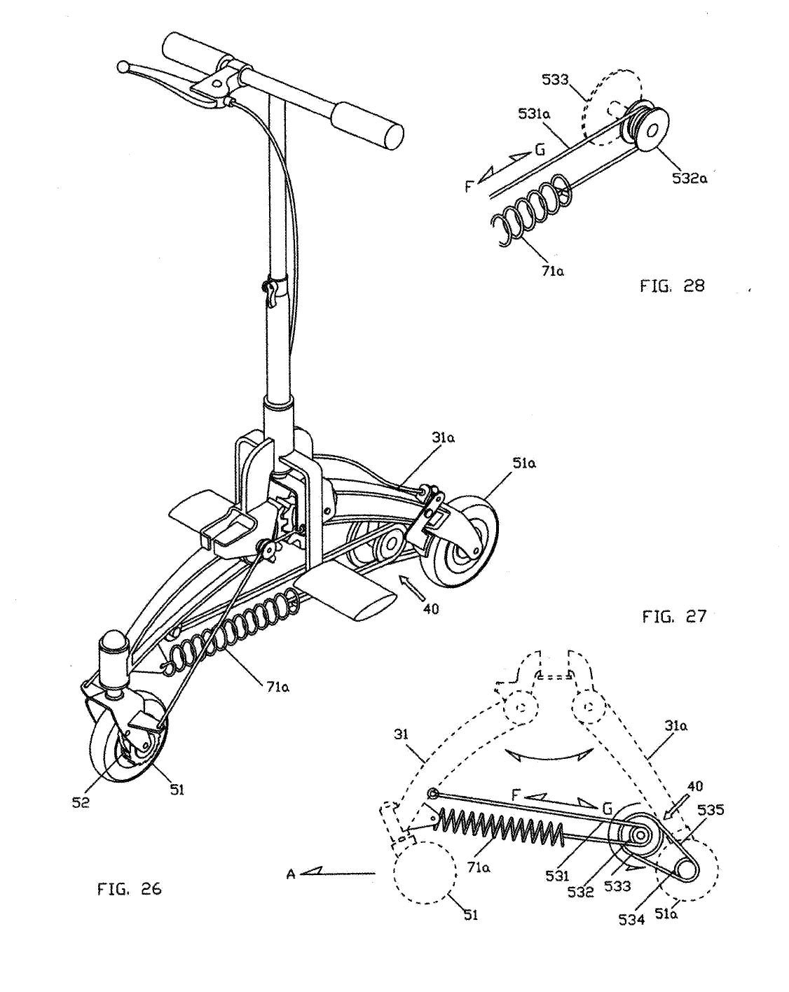

FIG. 26 is a perspective view of fourth embodiment of the invention with pull-chain accelerator 40.

FIG. 27 is a diagram of pull-chain accelerator 40. While front driving-leg 31 and rear driving-leg 31a apart each other, spring 71a will extend and pull-chain 531 would make chain-wheel 532 to turn. Accelerating-wheel 533 is secured to chain-wheel 532 and turns synchronously. Free-wheel 534 also turns driven by chain 535 connecting accelerating chain-wheel 533 and free-wheel 534 secured to rear wheel 51a.

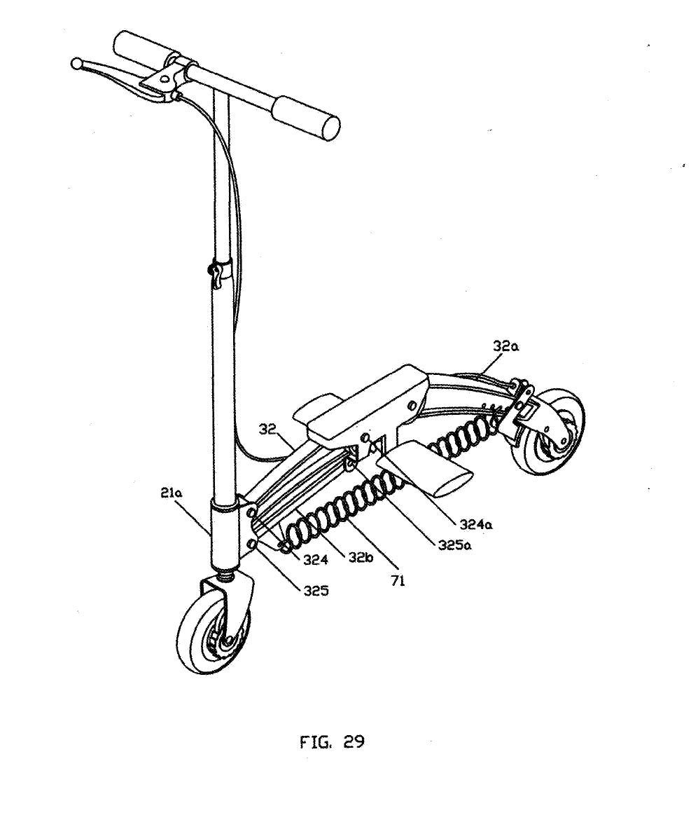

FIG. 28 shows in model pull-chain accelerator, chain wheel 532 is replaced by friction drive wheel 532a with soft cable 531a around it.

FIG. 29 is a perspective view of fourth embodiment of scooter with hand grips in the front. Elastic thing 71 provide under front and rear driving-legs 32 and 32a. A rod 32b is provided below front driving-leg 32 parallelly. Front driving-leg 32 and rod 32b both joint with hinge axles 324 and 324a as well 325 and 325a forming parallelogram to keep axle sleeve 21a upright.

Although preferred embodiment of the present invention has been shown in the foregoing specification, it will, of course, be understood that various modifications and changes may be made therein without departing from the invention. It is therefore, intended that the following claims cover all such modification and changes as may fall within the true spirit and scope of the present invention.

What is claimed is:

1. A jumping drive device comprising:
(a) a support means having lower part provided with front bearing and rear bearing;
(b) a front driving-kg means rotatively connected with upper end to said front bearing;
(c) a front fork rotatively mounted to lower end of said front driving-leg means;
(d) a front wheel provided with one-way clutch rotatively mounted on said front fork;
(e) a rear driving-leg means rotatively connected with upper end to said rear bearing;
(f) a rear fork provided at lower end of said rear driving-leg means;
(g) a rear wheel provided with one-way clutch rotatively mounted to said rear fork;
(h) synchronous device means;
(i) elastic thing means.

2. A device according to claim 1 wherein said synchronous device means provided at both upper ends of said front driving-leg means and said rear driving-leg means comprises two fan-shaped gears.

3. A device according to claim 1 wherein said rear driving-leg means is provided with two rear wheels.

4. A device according to claim 1 wherein said rear driving-leg means is provided at its lower end with gear-accelerator means.

5. A device according to claim 1 wherein said rear driving-leg means is provided at its lower end with pulling-accelerator means.

6. A device according to claim 1 wherein said rear driving-leg means is provided at its lower end with pull-chain accelerator means.

7. A device according to claim 1 wherein said front driving-leg means is provided at its lower end with support means.

8. A according to claim 4 wherein said gear-accelerator means comprises a auxiliary wheel, arc-rack, a one-way gear, a chain-wheel, a free-wheel and a chain.

9. A device according to claim 5 wherein said pulling-accelerator means comprises a soft-pull thing, a spiral return spring, a spiral return spring groove and a set of one-way clutch.

10. A device according to claim 6 wherein said pull-chain accelerator means comprises a pull-chain, a chain-wheel, a accelerating chain-wheel and a free wheel.

11. A device according to claim 10 wherein said pull-chain accelerator means also comprises a soft cable, a friction wheel.
